(19) United States
(12) Patent Application Publication
(10) Pub. No.: US 2008/0101415 A1
(43) Pub. Date: May 1, 2008

(54) PRIVATE DATA TRANSMISSION VIA AN ANALOG BROADCAST TRANSMISSION

(75) Inventors: Rajesh Veeraraghavan, Bangalore (IN); Vibhore Goyal, Bangalore (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/552,921

(22) Filed: Oct. 25, 2006

(51) Int. Cl. H04J 1/00

(52) U.S. Cl. 370/485; 340/825.02; 455/3.04

(57) ABSTRACT

A method and system for sending private data to a subscriber via a broadcast analog transmission is provided. A service provider assigns to each subscriber a unique key that specifies a sub-channel (i.e., frequency) that is within a predetermined channel (i.e., broadcast band). Each subscriber is provided with a receiver unit that is configured to demodulate analog signals at the sub-channel indicated by the key that is assigned to the particular subscriber. A service provider system broadcasts over an analog network the private data intended for receipt by a specific subscriber utilizing the key that is assigned to the subscriber. Accordingly, although the service provider system broadcasts the private data, only the receiver unit that is configured to demodulate the analog signals at the sub-channel indicated by the key that is assigned to the specific subscriber will receive the private data.

### BACKGROUND

Analog broadcast transmission systems, such as traditional cable television and Community Antenna Television (CATV) are still in prevalent use in many regions throughout the world. Traditional cable television and CATV involve distributing the radio frequency spectrum into a number of standard 6 MHz television channels. Providers of traditional cable television and CATV provide television programming, FM radio programming, and other services to their subscribers by transmitting analog signals over the radio frequencies directly to the subscribers' television sets through fixed cables, such as fiber optic cables or coaxial cables.

Traditional cable television and CATV providers broadcast the analog signals for reception by all of the subscribers. All of the subscribers who receive the broadcast analog transmission are able to view the content transmitted via the analog signals. Because all of the subscribers who receive the broadcast analog transmission are able to view the content transmitted via the analog signals, analog broadcast transmission is unfortunately not well suited for the transmission of private or sensitive information targeted for a particular subscriber.

### SUMMARY

A method and system for sending private data to a subscriber via a broadcast analog transmission is provided. A service provider assigns to each subscriber a unique key that specifies a sub-channel (i.e., frequency) that is within a predetermined channel (i.e., broadcast band). Each subscriber is provided with a receiver unit that is configured to demodulate analog signals at the sub-channel indicated by the key that is assigned to the particular subscriber. The subscribers may obtain their individualized receiver units from the service provider or an authorized third party. A service provider system broadcasts over an analog network the private data intended for receipt by a specific subscriber utilizing the key that is assigned to the subscriber. Accordingly, although the broadcast of the private data intended for receipt by the specific subscriber is received by all of the receiver units, only the receiver unit that is configured to demodulate the analog signals at the sub-channel indicated by the key that is assigned to the specific subscriber will receive the private data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high-level block diagram illustrating an example environment in which a service provider system may operate.

FIG. 2 is a data structure diagram that illustrates an example logical data structure of the service provider system, according to some embodiments.

FIG. 3 is a block diagram that illustrates selected components of the receiver unit, according to some embodiments.

FIG. 4 is a block diagram that illustrates selected components of the receiver unit implemented within a mobile communication device, according to some embodiments.

FIG. 5 is a block diagram that illustrates the receiver unit interfacing with a conventional mobile communication device, according to some embodiments.

FIG. 6 is a flow diagram that illustrates the processing of the service provider system to send private data to a subscriber, according to some embodiments.

FIG. 7 is a flow diagram that illustrates the processing of the service provider system to send private data to a subscriber, according to other embodiments.

FIG. 8 is a flow diagram that illustrates the processing of the receiver unit to process private data transmission, according to some embodiments.

FIG. 9 is a flow diagram that illustrates the processing of the receiver unit to process private data transmission, according to other embodiments.

FIG. 10 is a flow diagram that illustrates the processing of the receiver unit, according to some embodiments.

### DETAILED DESCRIPTION

A method and system for sending private data to a subscriber via a broadcast analog transmission is provided. A service provider assigns to each subscriber a unique key that specifies a sub-channel (i.e., frequency) that is within a predetermined channel (i.e., broadcast band). Each subscriber is provided with a receiver unit that is configured to demodulate analog signals at the sub-channel indicated by the key that is assigned to the particular subscriber. The subscribers may obtain their individualized receiver units from the service provider or an authorized third party. In some embodiments, a service provider system broadcasts over an analog network the private data intended for receipt by a specific subscriber utilizing the key that is assigned to the subscriber. Accordingly, although the broadcast of the private data intended for receipt by the specific subscriber is received by all of the receiver units, only the receiver unit that is configured to demodulate the analog signals at the sub-channel indicated by the key that is assigned to the specific subscriber will receive the private data.

In a typical scenario, the service provider system maintains a record of the subscribers and each subscriber's assigned key. When the service provider system identifies private data (e.g., sensitive and/or personal information such as financial information, etc.) that needs to be sent to a specific subscriber, the service provider system converts the private data into a set of one or more frames that contain (display) the private data. The service provider system then converts the set of frames, which is in digital form, to analog signals. The service provider system then modulates the analog signals at the frequency (i.e., the sub-channel within the predetermined channel) indicated by the key that is assigned to the specific subscriber, and broadcasts the modulated analog signals in an analog network for receipt at the predetermined channel. The service provider would have previously informed each of the subscribers of the predetermined channel over which the service provider system would transmit any private data intended for any of the subscribers. The broadcast analog signals are then received at each of the receiver units that are coupled to the analog network. Because each receiver unit is configured to demodulate the received analog signals at the frequency indicated by the key that is assigned to a single subscriber, the receiver unit belonging to the specific subscriber to whom the private data is intended will successfully demodulate the received analog signals to produce the private data. All the other receiver units (i.e., the receiver units that are configured to demodulate the received analog signals at a frequency other than that indicated by the key assigned to the intended subscriber) will not be able to successfully demodulate the received analog signals to produce the private data. Upon successfully demodulating the received analog signals to produce the private data, the receiver unit transmits the private data (e.g., the set of frames that display the private data), for example, to a coupled television set for output on the television screen when tuned to the predetermined channel. In this manner, private data intended for receipt by a specific subscriber can be transmitted to the intended subscriber via an analog broadcast transmission.

In some embodiments, the service provider system periodically broadcasts the same private data intended for receipt by a specific subscriber over a predetermined period of time. Periodically broadcasting the same private data allows the intended subscriber to receive and view the private data even though the intended subscriber may have missed a number of earlier broadcasts of the private data.

In some embodiments, the receiver unit may provide a signal (e.g., an audible signal or a visible signal) upon starting the receipt of private data (i.e., the successful demodulation of the private data). Upon receiving the signal, the subscriber can tune the television set coupled to the receiver unit to the predetermined channel and view the received private data on the television screen.

In some embodiments, the receiver unit may provide a user control that allows the subscriber or other user to request the storing of the private data in memory. For example, the receiver unit may provide a signal upon starting the receipt of private data. Upon detecting (e.g., hearing, seeing, etc.) the signal, the subscriber can activate the user control provided on the receiver unit to request storing of the private data that is being received by the receiver unit. Upon detecting the activation of the user control, the receiver unit can store the received private data in memory. The receiver unit can then transmit the stored private data, for example, to a coupled television set, for viewing when tuned to the predetermined channel. In some embodiments, the receiver unit transmits the stored private data to a coupled television set upon receiving a command to transmit (e.g., the subscriber activating a control provided by the receiver unit to request transmission of the stored private data). In some embodiments, the receiver unit repeatedly transmits the stored private data for a predetermined period of time.

In some embodiments, the service provider system generates a header that signals the transmission of private data and broadcasts the header along with the private data. For example, the service provider system can append the header to the set of frames that display the private data, convert the header and the set of frames to analog signals, modulate the analog signals at the frequency indicated by the key that is assigned to the intended subscriber, and broadcast the modulated analog signals in an analog network for receipt at the predetermined channel. When the receiver unit associated with the intended subscriber (i.e., the receiver unit that is configured to demodulate the received analog signals at a frequency indicated by the key assigned to the intended subscriber) successfully demodulates the header, the receiver unit can start storing the demodulated private data in memory. The receiver unit can then repeatedly transmit the stored private data, for example, to a coupled television set for viewing when tuned to the predetermined channel. In this manner, the header functions as an indication to the receiver unit that private data is to be received, which allows the receiver unit to properly process the private data (e.g., store the received private data in memory). In some embodiments, the receiver unit can also provide a signal to indicate the receipt of private data upon successfully demodulating the header.

In some embodiments, a subscriber can request the transmission of his or her private data. For example, the subscriber can call or otherwise inform (e.g., send a text message, send an email, etc.) the service provider of the subscriber's desire to receive his or her private data. Upon receiving the request, the service provider system can broadcast the subscriber's private data over an analog network for receipt by the subscriber's receiver unit.

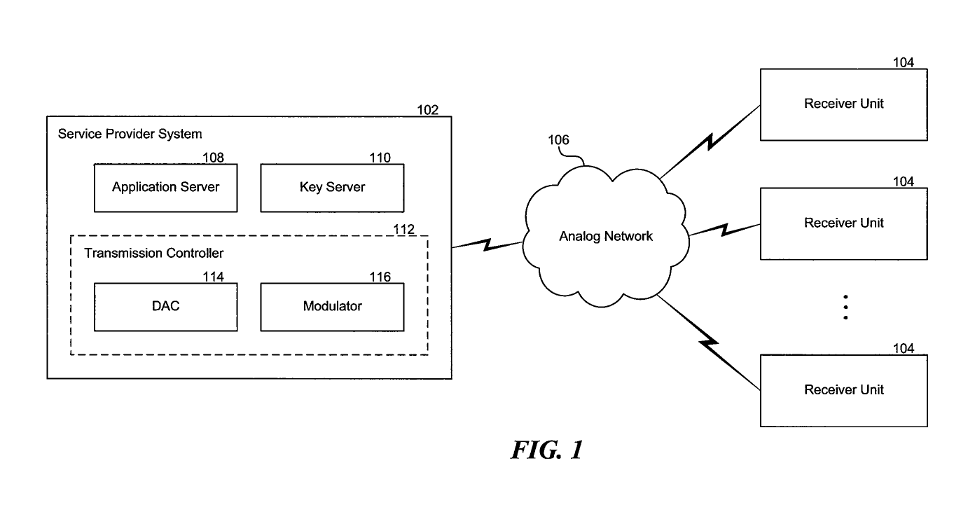

FIG. 1 is a high-level block diagram illustrating an example environment in which a service provider system may operate. The environment comprises a service provider system 102 coupled to a plurality of receiver units 104 via an analog network 106. The service provider system provides services, such as financial services, billing service, government services, etc. to subscribers. In providing the services, the service provider system sends to a subscriber information and data that is private to the subscriber (private data). Each subscriber is assigned a unique key that distinguishes the subscriber from the other subscribers. The receiver units correspond to the subscribers, and each subscriber is provided (associated with) a receiver unit that is controlled by the key assigned to that subscriber. The receiver unit is further discussed below. The analog network facilitates the transmission of analog signals. Examples of the analog network include a cable television network, a CATV network, etc. The service provider system comprises an application server 108, a key server 110, and a transmission controller 112. The key server manages the assignment of keys to their respective subscribers. The application server hosts one or more application programs related to the services provided by the service provider system. The application server identifies private data that needs to be sent to a subscriber, identifies a key that is assigned to the subscriber, generates a set of frames that contains the private data, and invokes the transmission controller to broadcast the private data to the subscriber. The transmission controller controls the transmission of the data over the analog network. The transmission controller comprises a DAC (digital-to-analog converter) component 114 and a modulator component 116. The DAC component converts the set of frames of containing the private data, which is in digital code, to analog signals. The modulator component modulates the analog signals generated by the DAC over a frequency (i.e., a sub-channel within the predetermined channel) as indicated by a specified key. Although not shown in FIG. 1, the service provider system includes components to couple the service provider system to the analog network and to broadcast the analog signals over the analog network.

The computing device on which the service provider system is implemented may include a central processing unit, memory, input devices (e.g., keyboard and pointing devices), output devices (e.g., display devices), and storage devices (e.g., disk drives). The memory and storage devices are computer-readable media that may contain computer executable instructions that implement the presence information system. As used herein, “computer-readable media encoded with computer executable instructions” means computer-readable media comprising computer executable instructions. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on.

Embodiments of the service provider system, including the receiver unit, may be implemented in various operating environments that include personal computers, server computers, hand-held or laptop devices, multiprocessor systems, microprocessor-based systems, programmable consumer electronics, digital cameras, set-top boxes, network PCs, minicomputers, mainframe computers, network devices, distributed computing environments that include any of the above systems or devices, and so on. The computer systems may be cell phones, personal digital assistants, smart phones, personal computers, programmable consumer electronics, digital cameras, and so on.

The service provider system and the receiver unit may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

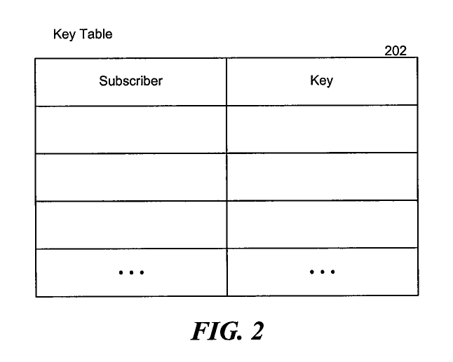

FIG. 2 is a data structure diagram that illustrates an example logical data structure of the service provider system, according to some embodiments. In particular, FIG. 2 illustrates a key table 202 of the service provider system. The key table maps each subscriber to the subscriber's assigned key. The key table contains an entry for each subscriber that identifies a key of that subscriber. The identified key specifies a sub-channel at which the associated subscriber can receive private data that is intended for the subscriber. One skilled in the art will appreciate that this is only one example of the logical layout of the key table, and the key table and the other data structures of the service provider system may be tailored to the space/computation requirements of the service provider system.

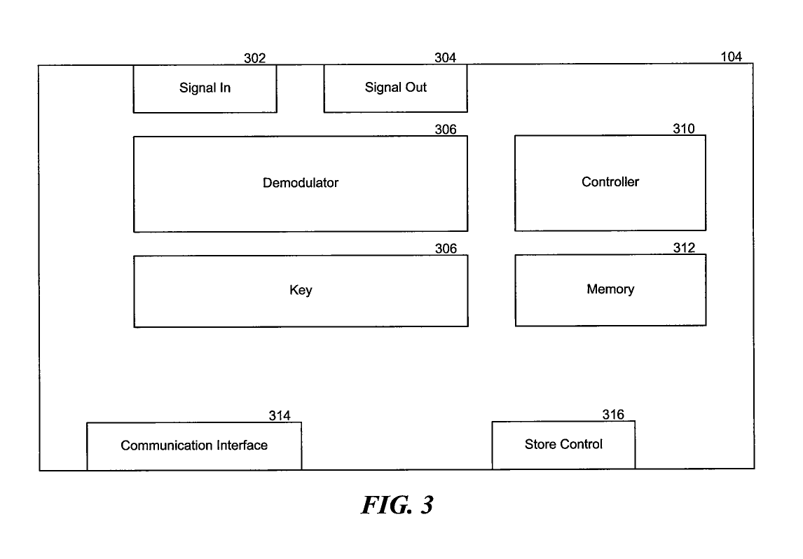

FIG. 3 is a block diagram that illustrates selected components of the receiver unit, according to some embodiments. The receiver unit may be used to receive the broadcast analog signals, process the received analog signals, and produce the processed analog signals to a coupled television set for output on the television screen. The receiver unit comprises a signal in interface 302, a signal out interface 304, a demodulator component 306, a key component 308, a controller component 310, a memory component 312, a communication interface 314, and a store control 316. The controller component controls the operation of the receiver unit. The signal in interface facilitates connection of the receiver unit to the analog network and functions to receive the analog signals transmitted over the analog network. The key component specifies a sub-channel that is associated with the receiver unit, and specifies to the demodulator the sub-channel at which the demodulator component is to demodulate the received analog signals. The demodulator component demodulates the received analog signals at a sub-channel as controlled by the key component in order to recover any information content transmitted at the sub-channel of the received analog signals. The memory component facilitates the storage and retrieval of information/data, including the demodulated analog signals. The signal out interface facilitates the connection of the receiver unit to a viewing device, such as a television set for outputting the analog signals processed by the receiver unit. The communication interface facilitates the coupling of the receiver unit to other devices, such as electronic devices, computing devices, etc., and the communication of the receiver unit with the coupled device. The store control is an input control that may be activated to request storing of the demodulated analog signals in the memory component of the receiver unit. In a typical operation, the subscriber can activate (e.g., depress) the store control to request storing of the private data that is being received by the receiver unit. In some embodiments, the functionality provided by the various components of the receiver unit may be implemented as part of a set-top box, computing device, or other signaling device capable of connecting to the analog network and producing signals for output on a television screen. One skilled in the art will appreciate that this is only one example of the logical layout of the components of the receiver unit. The components of the receiver unit may be tailored to the space/computation requirements of the receiver unit, including various other devices in which the receiver unit may be housed and, as such, one or more of the depicted components may not be provided in the receiver unit. For example, the receiver unit may not include the communication interface and/or the store control. Conversely, the receiver unit may include other components not depicted in the receiver unit depicted in FIG. 3.

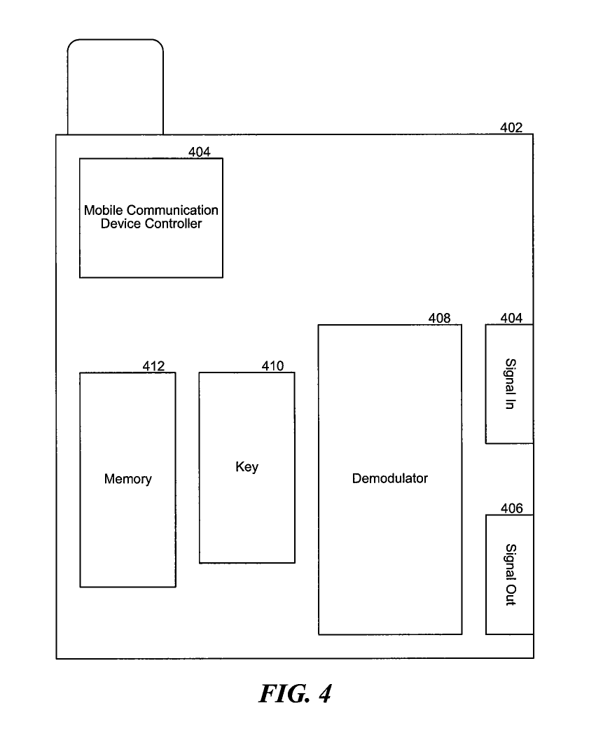

FIG. 4 is a block diagram that illustrates selected components of the receiver unit implemented within a mobile communication device, according to some embodiments. As depicted, a mobile communication device 402 comprises a mobile communication device controller 404, a signal in interface 404, a signal out interface 406, a demodulator component 408, a key component 410, and a memory component 412. The mobile communication device controller controls the operation of the mobile communication device. For example, in the instance where the mobile communication device is a cellular telephone, the mobile communication device controller may be a central processing unit that controls the functioning of the cellular telephone. The signal in interface, signal out interface, demodulator component, key component, and memory component function in substantially the same manner as described above in conjunction with the receiver unit illustrated in FIG. 3. The mobile communication device and, in particular, the receiver unit functionality implemented within the mobile communication device allows the receiver unit to function as a portable device that can easily be transported and connected to the analog network and the television set to receive the private data. By way of example, in addition to using the mobile communication device as a conventional communication unit to make and receive telephone calls, text messages, and to perform various other functions provided by the mobile communication device, a subscriber can readily connect the mobile communication device to the analog network and a television set as desired in order to receive the private data intended for the subscriber.

In some embodiments, the mobile communication device can be used to dynamically program the key component of the receiver unit with a key. In an example scenario, a subscriber may have been assigned a key and may currently be using a mobile communication device as illustrated in FIG. 4 to receive private data from the communication service provider. Subsequently, the service provider system may assign a new key to the subscriber. The service provider system may then send the new key to the subscriber via a Short Message Service (SMS) message to the subscriber's mobile communication device. For example, the new key may be specified using Extensible Markup Language (XML) or other suitable markup or description language, and the XML specifying the new key may be sent as an SMS message to the subscriber's mobile communication device. Upon receiving the new key, a component of the mobile communication device, such as the mobile communication device controller, may program the key component with the new key, thus causing the demodulator component to demodulate received analog signals at the new key as controlled by the key component.

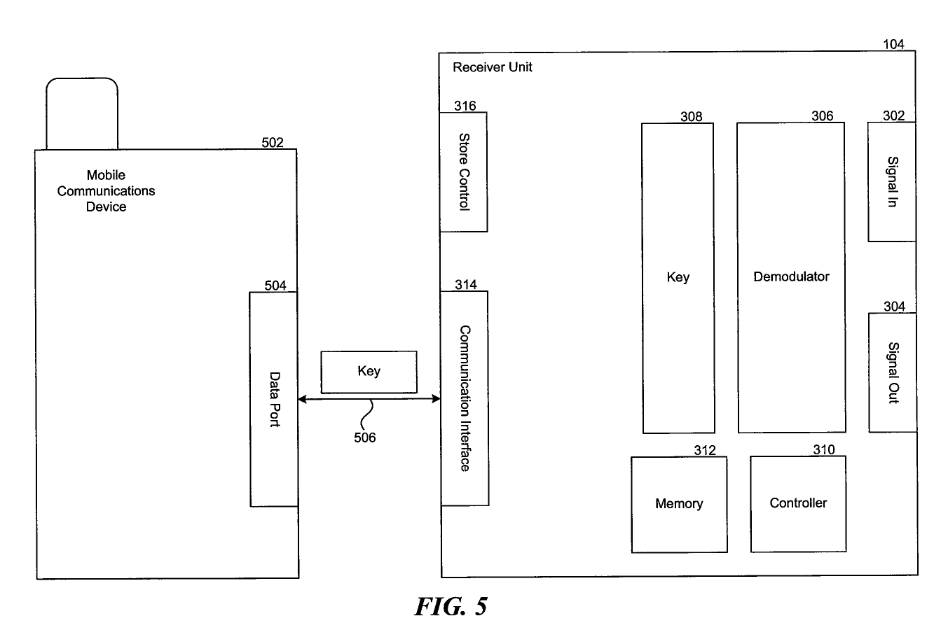

FIG. 5 is a block diagram that illustrates the receiver unit interfacing with a conventional mobile communication device, according to some embodiments. The conventional mobile communication device can interface with the receiver unit to send the receiver unit a key, thus allowing the receiver unit to be dynamically programmed with a key using the conventional mobile communication device. As depicted, a conventional mobile communication device 502 is coupled to the receiver unit. More specifically, a data port 504 of the conventional mobile communication device is coupled to the communication interface of the receiver unit via a communication cable 506 which is used to transmit the key from the conventional mobile communication device to the receiver unit. In an example scenario, a subscriber may have been assigned a key and a receiver unit configured to function as controlled by the key. Subsequently, the service provider system may assign a new key to the subscriber. The service provider system may then send the new key to the subscriber via an SMS message to the subscriber's conventional mobile communication device. Upon receiving the new key, the subscriber can connect the conventional mobile communication device to the receiver unit and instruct the conventional mobile communication device to transmit the new key out the data port to the connected receiver unit. Upon receiving the new key, a component of the receiver unit, such as the controller component, may program the key component with the new key, thus causing the demodulator component to demodulate received analog signals at the new key as controlled by the key component.

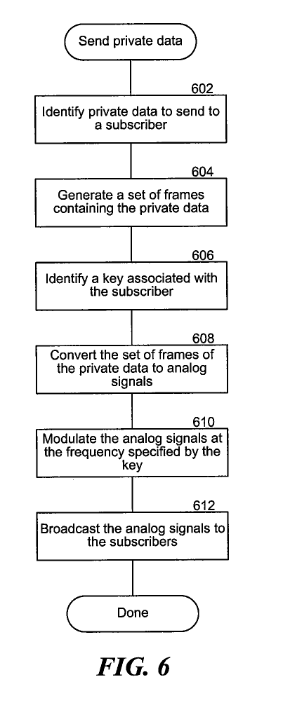

FIG. 6 is a flow diagram that illustrates the processing of the service provider system to send private data to a subscriber, according to some embodiments. The service provider system sends private data that is intended for receipt by a specific subscriber via a broadcast transmission over the analog network. In block 602, the application server of the service provider system identifies private data to send to a subscriber. In block 604, the application server generates a set of frames that contain the private data. For example, the set of frames may be one or more pages, such as hypertext markup language (HTML) pages, that display the private data. In block 606, the application server identifies a key that is assigned to the subscriber. The application server can identify the key from the key server. In block 608, the application server invokes the DAC component of the transmission controller to convert the set of frames containing the private data to analog signals. In block 610, the DAC component outputs the analog signals to the modulator component for modulation of the analog signals at the sub-channel specified by the identified key that is assigned to the subscriber. In block 612, the transmission controller broadcasts the analog signals to the subscribers over the analog network. The service provider system then completes.

One skilled in the art will appreciate that, for this and other processes and methods disclosed herein, the functions/steps performed in the processes and methods may be altered in various ways. For example, the order of the outlined steps is only exemplary, and the steps may be rearranged, some of the steps may be optional, substeps may be performed in parallel, some of the steps may be combined into fewer steps or expanded into additional steps, other steps may be included, etc.

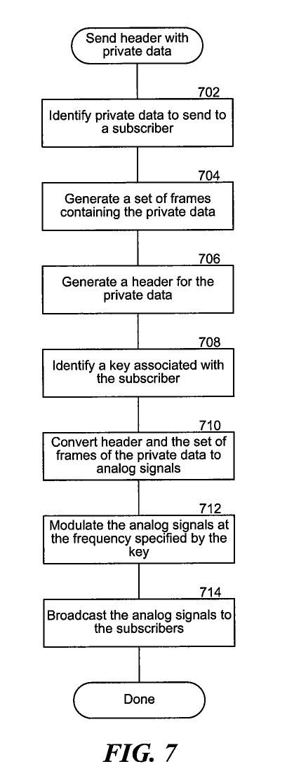

FIG. 7 is a flow diagram that illustrates the processing of the service provider system to send private data to a subscriber, according to other embodiments. The service provider system sends private data that is intended for receipt by a specific subscriber via a broadcast transmission over the analog network. In addition to the private data, the service provider system also broadcasts a header that functions to signal the transmission of the private data. In block 702, the application server of the service provider system identifies private data to send to a subscriber. In block 704, the application server generates a set of frames that contain the private data. In block 706, the application server generates a header for the set of frames. The header functions to signal the transmission and impending receipt of the private data. In block 708, the application server identifies a key that is assigned to the subscriber. In block 710, the application server invokes the DAC component of the transmission controller to convert the header and the set of frames containing the private data to analog signals. In block 712, the DAC component outputs the analog signals to the modulator component for modulation of the analog signals at the sub-channel specified by the identified key that is assigned to the subscriber. In block 714, the transmission controller broadcasts the analog signals to the subscribers over the analog network. The service provider system then completes.

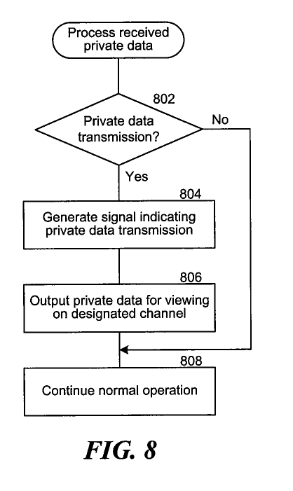

FIG. 8 is a flow diagram that illustrates the processing of the receiver unit to process private data transmission, according to some embodiments. The receiver unit demodulates the analog signals received at a sub-channel as controlled by a key that is configured (programmed) in the receiver unit. Upon successfully demodulating private data transmitted at the sub-channel, the receiver unit generates a signal to indicate the receipt of the private data. In decision block 802, if the receiver unit successfully demodulates private data at the sub-channel as controlled by the key that is configured in the receiver unit, then the receiver unit continues at block 804, else the receiver unit continues normal processing at block 808. In block 804, the receiver unit generates a signal to indicate the receipt of private data. The signal may be an audible signal output via a speaker on the receiver unit and/or a visible signal using, for example, an LED on the receiver unit. In block 806, the receiver unit outputs the private data (e.g., the set of frames containing the private data) via the signal out component to a coupled television set for viewing when tuned to the predetermined channel. The receiver unit then continues normal processing in block 808.

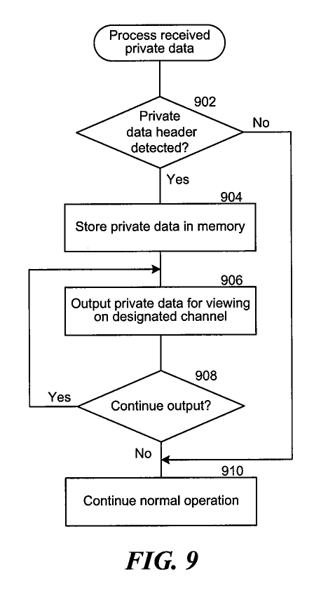

FIG. 9 is a flow diagram that illustrates the processing of the receiver unit to process private data transmission, according to other embodiments. The receiver unit demodulates the analog signals received at a sub-channel as controlled by a key that is configured (programmed) in the receiver unit. Upon successfully demodulating private data transmitted at the sub-channel, the receiver unit stores in memory the received private data. In decision block 902, if the receiver unit successfully demodulates a private data header at the sub-channel as controlled by the key that is configured in the receiver unit, then the receiver unit continues at block 904, else the receiver unit continues normal processing at block 910. In block 904, the receiver unit stores the demodulated frames of private data in memory. In block 906, the receiver unit outputs the stored frames of private data via the signal out component to a coupled television set for viewing when tuned to the predetermined channel. In decision block 908, if receiver unit needs to continue to output the stored frames of private data, then the receiver unit loops to block 906 and continues to output the stored frames of private data via the signal out component to a coupled television set for viewing, else the receiver unit continues normal processing at block 910. Continuously outputting the stored frames of private data for viewing allows the subscriber ample opportunity to tune the television set to the predetermined channel and view the private data. By way of example, the receiver unit may continuously output the stored frames of private data for viewing for a predetermined period of time, such as one hour, 12 hours, etc. In some embodiments, the receiver unit may continuously output the stored frames of private data for viewing until the receiver unit successfully demodulates and stores frames of new private data. The receiver unit may then continuously output the stored frames of new private data for viewing.

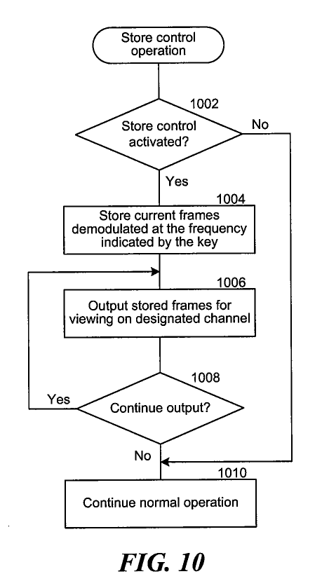

FIG. 10 is a flow diagram that illustrates the processing of the receiver unit, according to some embodiments. The receiver unit stores in memory the frames demodulated at the sub-channel indicated by the key that is configured (programmed) in the receiver unit upon receiving a command to store the currently demodulated frames. In decision block 1002, if the store control on the receiver unit is activated, then the receiver unit continues at block 1004, else the receiver unit continues normal processing at block 1010. In block 1004, the receiver unit starts storing in memory the frames that are currently being demodulated at a sub-channel as controlled by a key that is configured (programmed) in the receiver unit. By way of example, if the receiver unit provided a signal to indicate the start of the receipt of private data and the subscriber activated the store control in response to receiving the signal, then the receiver unit starts storing in memory the frames of private data that are currently being demodulated. The store control may have been activated even when private data is not currently being received by the receiver unit. In this instance, the receiver unit may start storing in memory the frames that are currently being demodulated, even though the frames do not contain private data. In block 1006, the receiver unit outputs the stored frames via the signal out component to a coupled television set for viewing when tuned to the predetermined channel. In decision block 1008, if receiver unit needs to continue to output the stored frames, then the receiver unit loops to block 1006 and continues to output the stored frames via the signal out component to a coupled television set for viewing, else the receiver unit continues normal processing at block 1010.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, although the analog signals have been described as representing a set of one or more video frames, the analog signals are not limited to representing a set of video frames. For example, the private data may be audio information, and the analog signals may represent a set of one or more audio frames. Accordingly, the invention is not limited except as by the appended claims.

I/We claim:

1. A method for sending private data via an analog broadcast transmission, the method comprising:
determining that private data is to be sent to a subscriber;
identifying a sub-channel within a predetermined channel, the sub-channel being associated with the subscriber and not any other subscriber; and
broadcasting analog signals over the identified sub-channel associated with the subscriber, the broadcast analog signals transmitting the private data.

2. The method of claim 1, wherein the analog signals transmitting the private data is repeatedly broadcast for a predetermined period of time.

3. The method of claim 1, wherein the analog signals comprise an indication that the private data is being transmitted.

4. The method of claim 3, wherein the indication is an audible indication.

5. The method of claim 3, wherein the indication is a signal indicating that the transmitted private data is to be stored.

6. The method of claim 1, wherein the analog signals are broadcast in response to a request from the subscriber.

7. The method of claim 6, wherein the request is received via a communications medium distinct from the communications medium utilized for broadcasting the analog signals.

8. The method of claim 1, wherein the analog signals are broadcast over an analog cable television network.

9. The method of claim 1, wherein the analog signals are broadcast over an analog CATV network.

10. An analog signal receiving apparatus comprising:
a first interface component that receives transmitted analog signals;
a key that specifies a sub-channel within a predetermined channel;
a demodulator component that processes received analog signals by demodulating the analog signals received at the sub-channel as controlled by the key; and
a second interface component that outputs the processed analog signals including the demodulated analog signals received at the sub-channel,
such that information transmitted over the sub-channel is retrievable by tuning to the predetermined channel.

11. The apparatus of claim 10 further comprising a controller component that, upon detecting an indication that data is being transmitted over the sub-channel, stores the demodulated analog signals representing the data.

12. The apparatus of claim 11, wherein the indication is contained in the analog signals received at the sub-channel.

13. The apparatus of claim 11, wherein the controller component repeatedly transmits the stored demodulated analog signals representing the data over the sub-channel as part of the output analog signals.

14. The apparatus of claim 13, wherein the controller component repeatedly transmits the stored demodulated analog signals representing the data over the sub-channel as part of the output analog signals until the demodulator component demodulates new data transmitted over the sub-channel.

15. The apparatus of claim 10, wherein the apparatus is contained within a set-top box.

16. The apparatus of claim 10, wherein the apparatus is contained within a mobile communications device.

17. The apparatus of claim 10 further comprising a third interface component, and wherein the apparatus receives the key via the third interface component.

18. The apparatus of claim 17, wherein the key is received via the third interface component from a mobile communications device.

19. The apparatus of claim 10 further comprising an input component for requesting the storing of the demodulated analog signals that represent data that is being transmitted over the sub-channel.

20. A system for sending private data via an analog broadcast transmission, the private data for reception by a single subscriber, the system comprising:
a component that determines that the private data is to be sent to the subscriber;
a component that identifies a frequency within a predetermined frequency range, the identified frequency being associated with the subscriber and not any other subscriber;
a component that modulates the private data into analog signals over the identified frequency associated with the subscriber; and
a component that broadcasts the analog signals.
